(19) United States
(12) Patent Application Publication
(10) Pub. No.: US 2014/0232783 A1
(43) Pub. Date: Aug. 21, 2014

(54) Printing Systems and Printing Methods

(71) Applicants: Jaime Fernandez del Rio, San Diego, CA (US); Eduardo Amela Conesa, Granyena de Segarra Lleida (ES); Marc Serra Vall, Barcelona (ES); Jacint Humet Pous, Santa Perpetua de Mogoda Barcelona (ES)

(72) Inventors: Jaime Fernandez del Rio, San Diego, CA (US); Eduardo Amela Conesa, Granyena de Segarra Lleida (ES); Marc Serra Vall, Barcelona (ES); Jacint Humet Pous, Santa Perpetua de Mogoda Barcelona (ES)

(73) Assignee: HEWLETT-PACKARD DEVELOPMENT COMPANY, L.P., Houston, TX (US)

(21) Appl. No.: 14/346,930

(22) PCT Filed: Oct. 6, 2011
(86) PCT No.: PCT/EP2011/067507

§ 371 Date: Mar. 24, 2014

(51) Int. Cl. B41J 11/00

(52) U.S. Cl. CPC B41J 11/0015
USPC 347/21

(57) ABSTRACT

A printing method is described herein. A fixer fluid is applied to a print area. The areal density of fixer fluid in a boundary region of the print area is different than the areal density of fixer fluid in an interior region of the print area. The print area corresponds to an image portion to be printed with a uniform color.

### BACKGROUND

Some printing systems form a printed image by ejecting ink from ink printheads. Thereby, ink is applied onto a print medium for printing a pattern of individual dots at particular locations. The printed pattern reproduces an image on the printing medium. At least some of these printing systems are commonly referred to as inkjet printers.

A fixer fluid may be used for facilitating print quality of a printed pattern. For example, a fixer fluid may be used for addressing coalescence, bleed, feathering, or similar effects characterized by ink or pigment migration across a printed surface. Common methods for applying a fixer fluid include roll coating, spray coating, manual application and ejection. Ejection of fixer fluid is often implemented using a treatment printhead. The fixer fluid may be applied before, after or, quasi-simultaneously to the application of ink on a print medium. A fixer fluid to be applied before application is also referred to as a pretreatment fluid. Pretreatment fluids are often applied as a uniform layer.

The use of a fixer fluid may have drawbacks such as a reduction in gloss of the printed image as well as an increase of the total amount of used fluid. Therefore, use of a fixer fluid without compromising print quality of a printed pattern can be challenging. Further, an accurate positioning of fixer fluids may pose problems, since at least some fixer fluids are transparent to alignment sensors commonly provided in a printer system.

### BRIEF DESCRIPTION OF THE DRAWINGS

The Figures depict examples, implementations, and configurations of the invention, and not the invention itself.

FIG. 1 is a block diagram of a printing system according to an example herein.

FIG. 2 is a process flow diagram of a method performed by a printing system according to an example herein.

FIGS. 3A, 3B, and 3C are simplified diagrams of printing patterns printed by a printing system according to examples herein.

FIG. 4 is a graphical diagram of a method performed by a printing system according to an example herein.

FIG. 5 is a schematically diagram illustrating an arrangement for operating a printing system according to an example herein.

FIG. 6 is a simplified diagram of a printing pattern printed by a printing system according to an example herein.

### DETAILED DESCRIPTION

In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the examples.

In the foregoing description, numerous details are set forth to provide an understanding of the examples disclosed herein. However, it will be understood by those skilled in the art that the examples may be practiced without these details. Further, in the following detailed description, reference is made to the accompanying drawings, in which various examples are shown by way of illustration. In this regard, directional terminology, such as “top,” “bottom,” “front,” “back,” “leading,” “trailing,” “left,” “right,” “vertical,”, etc., is used with reference to the orientation of the Figure(s) being described. Because disclosed components can be positioned in a number of different orientations, the directional terminology is used for purposes of illustration and is in no way limiting.

While a limited number of examples have been disclosed, those skilled in the art will appreciate numerous modifications and variations therefrom. It is intended that the appended claims cover such modifications and variations as fall within the true spirit and scope of the examples.

A fixer fluid is a fluid that facilitates reducing mobility of ink on a print medium. Typically, fixer fluids are materials that may be applied beneath a colored ink drop (pre-coats or undercoats) and/or materials that may be applied over a colored ink drop (post-coats or overcoats). Further examples of fixer fluids are detailed below. A fixer fluid may be used for improving print quality of a printed pattern by addressing at least one of coalescence, bleed, feathering or similar effects characterized by ink or pigment migration across a printed surface.

Color bleeding refers to unwanted mixing of ink applied onto a particular area for uniformly reproducing a color with ink applied onto a surrounding area for uniformly reproducing another color. Feathering refers to unwanted spreading of ink outside of a print area. Color bleeding and feathering generally affect boundary regions of a print areas. Coalescence refers to non-uniformity in solid fill areas caused by unwanted merging of ink droplets on the print medium. Coalescence generally affects interior areas of print areas.

A fixer fluid may be used for addressing ink migration effects. Ink migration affects differently different regions of a print area. For example, color bleeding and feathering affects the boundary region of a print area while coalescence affects the interior region of a print area. It should be noted that, generally, the quantity of fixer fluid required for addressing each effect is different. Generally, coalescence can be addressed using a lower quantity of fixer fluid as compared to addressing color bleeding. In such cases, it might be more efficient to use a higher quantity of fixer fluid for addressing color bleeding and a lower quantity of fixer fluid for addressing coalescence. However, for some particular colors, color bleeding may not have a significant effect. For example, color bleeding is hardly noticeable for some particular colors. In such cases, it might be more efficient to use a higher quantity of fixer fluid for addressing coalescence and a lower quantity of fixer fluid for addressing color bleeding.

Therefore, applying different quantities of fixer fluid at different regions of a print area facilitates a more efficient use of fixer fluid. Methods and systems for printing by applying a fixer fluid are described herein. A fixer fluid is applied to a print area. The print area corresponds to an image portion to be printed with a uniform color. Typically, the print area is an area solidly and uniformly printed by applying ink for reproducing a particular color on the print area. It will be understood that the particular color is uniformly printed within the capabilities of the particular printing system and is subject to variations caused by system tolerances or unwanted ink migration.

The application of the fixer fluid is such that the areal density of fixer fluid in a boundary region of the print area is different than the areal density of fixer fluid in an interior region of the print area. As used herein, the areal density of fixer fluid in a particular region corresponds to the mass of fixer fluid applied to the particular region divided by the area of the particular region. The fixer fluid areal density in a particular region may be calculated prior to deposition by dividing the total mass of fixer fluid to be applied to the particular region by the area of that particular region. It will be understood that the difference in fixer fluid areal densities as described herein goes beyond tolerances of the particular system used for applying a fixer fluid.

An ink may include a fluid vehicle and a pigment and/or dye. A fixer fluid typically includes a fluid vehicle and a fixer composition that interacts with an ink. Generally, the higher the quantity of fluid vehicle is applied on a print medium, the longer time is required for a fixation of ink to the substrate. Reducing the quantity of applied fixer fluid, as facilitated by an efficient use of fixer fluid, promotes fixation of ink to the print medium.

Moreover, the interaction of fixer and ink may cause an unwanted reduction of color gloss. The reduction of color gloss generally depends on the quantity of applied liquid fluid: the higher the quantity of fluid vehicle is applied on a print medium, the higher may be the effect produced by color gloss. Therefore, reducing the quantity of applied fixer fluid, as facilitated by an efficient use of fixer fluid, prevents a reduction of color gloss.

An areal density of fixer fluid in the boundary region different than the areal density of fixer fluid in the interior region facilitates adapting the distribution of fixer fluid to the quantity of fixer fluid required for addressing, on the one hand, coalescence at the interior region of the print area and, on the other hand, color bleeding and feathering at the boundary region of the print area. Thereby, a fixer fluid may be applied efficiently so that the quantity of used fixer fluid can be reduced as compared, e.g., to a uniform application thereof without compromising print quality.

As used herein, a boundary region of a print area refers to a region adjacent or overlapping a border of the print area and extending along the border. It should be noted that a boundary region may partially or completely surround the print area. The boundary region may be disposed in different manners relative to the print area, as illustrated in examples herein. For example, the boundary region may be completely contained in the print area. Further, the boundary region may be completely outside of the print area. Further, the boundary region may extend within and outside the print area. An interior region corresponds to the region which forms part of the print area (i.e., contained within the edges of the print area) and does not overlap with the boundary region. Typically, the boundary region completely surrounds the interior region.

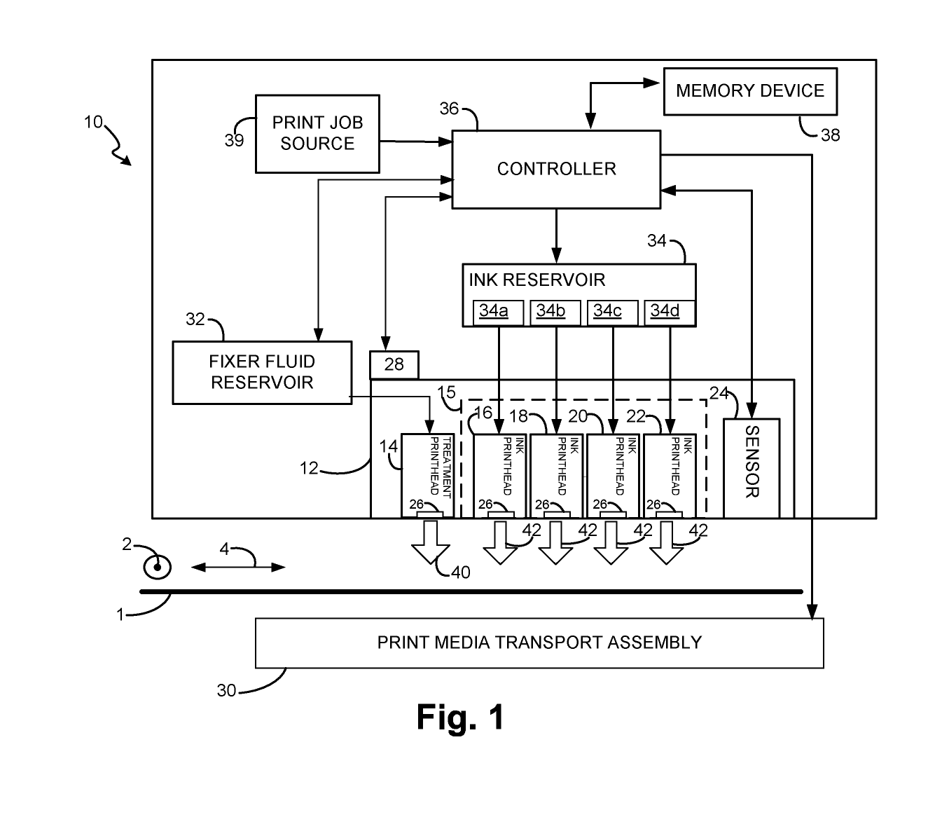

FIG. 1 is a block diagram of a printing system 10 according to an example herein. Printing system 10 is for reproducing an image on a print medium 1. Typically, printing system 10 is an inkjet printer. Printing system 10 includes a movable carriage 12 driven by a carriage drive 28 for traversing along a transition direction 4. In the illustrated example, carriage 12 supports four ink printheads 16, 18, 20, 22 (which constitute an ink printhead assembly 15), a treatment printhead 14, and an optical sensor 24 for locating printed areas on print medium 1. Further, printing system 10 includes a print media transport assembly 30, on which print medium 1 is supported and advanced in a media advance direction 2, which is perpendicular to the plane of the Figure. A controller 36 is configured for being operatively connected to the above elements of printing system 10 as well as a fixer fluid reservoir 32, an ink reservoir 34, a memory device 38, and a printjob source 39.

As used herein, a printhead is a device including a nozzle or nozzles 26 through which drops of a fluid (e.g., a fixer 40 or an ink 42) can be ejected. The particular fluid ejection mechanism within the printhead may take on a variety of different forms such as, but not limited to, those using piezo-electric or thermal printhead technology. Nozzles 26 may be arranged in different manners. Typically, each printhead includes multiple rows of nozzles arranged along media advance direction 2. The length of the rows of nozzles along the media advance direction defines a print swath. The width of this band along media advance direction 2 is commonly referred to as the “swath width”, which defines the maximum pattern of ink or fixer fluid which can be laid down in a single transition of carriage 12.

Each of ink printheads 16, 18, 20, 22 is configured to eject ink 42 of a different color (referred to as base colors). Ink printheads 16, 18, 20, 22 are fluidly connected to ink reservoir 34. Ink reservoir 34 includes separated reservoirs 34a, 34b, 34c, 34d for providing ink to the respective ink printhead. In the illustrated example, separated reservoirs 34a, 34b, 34c, 34d respectively store cyan ink, magenta ink, yellow ink, and black ink. Printing systems commonly employ a plurality of ink printheads to produce secondary colors by combining ink from different ink printheads. Base colors are reproduced on print medium 1 by depositing a drop of the required color onto a dot location. Secondary or shaded colors are reproduced by depositing drops of different base colors on adjacent dot locations; the human eye interprets the color mixing as the secondary color or shading.

A treatment printhead as used herein is a printhead configured to eject fixer fluid for treating an area of a print medium through a nozzle or an array of nozzles 26. The block diagram shows that treatment printhead 14 is fluidly connected to fixer fluid reservoir 32.

Typically, ink reservoir 34 and fixer fluid reservoir 32 include disposable cartridges (not shown). Further, the reservoirs may be mounted on carriage 12 in a position adjacent to the respective printhead. In other configurations (also referred to as off-axis systems), a small fluid supply (ink or fixer) is provided to cartridges (not shown) in carriage 12, each cartridge being associated to a respective printhead; main supplies for ink and fixer are then stored in the respective reservoirs. In an off-axis system, flexible conduits are used to convey the fluid from the off-axis main supplies to the corresponding printhead cartridge. Printheads and reservoirs may be combined into single units, which are commonly referred to as “pens”.

It will be appreciated that printing system 10 may include any number of printheads suitable for a particular application. In some examples, printing system 10 may include at least one treatment printhead, such as two or more treatment printheads. Printing system 10 may include at least one ink printhead, such as two to six ink printheads, or even more ink printheads. A printhead of printing system 10 may be a disposable printhead or a fixed printhead, which is designed to last for the whole operating life of printing system 10.

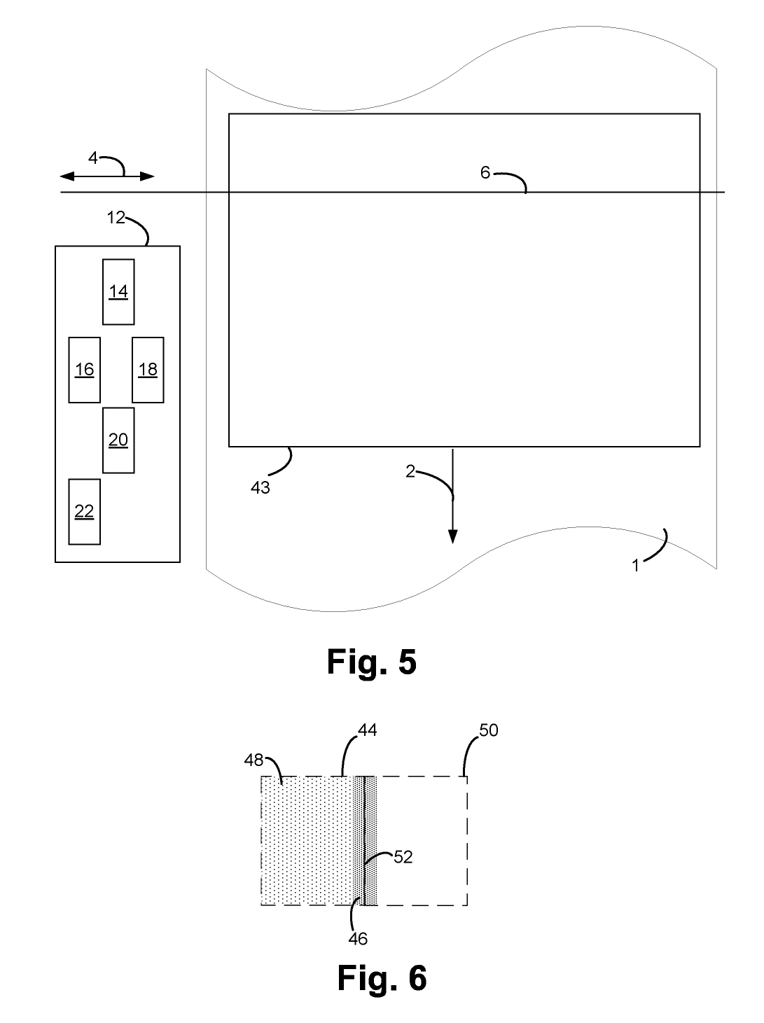

The printheads may be arranged in different configurations such as a linear configuration, in which the printheads are aligned along the direction of carriage transition (e.g. transition direction 4). In other examples, such as illustrated below with respect to FIG. 5, the printheads may be arranged in a staggered configuration.

Controller 36 is configured to execute methods described herein. Controller 36 may be implemented, for example, by one or more discrete modules (or data processing components) that are not limited to any particular hardware, firmware, or software (i.e., machine readable instructions) configuration. Controller 36 may be implemented in any computing or data processing environment, including in digital electronic circuitry, e.g., an application-specific integrated circuit, such as a digital signal processor (DSP) or in computer hardware, firmware, device driver, or software (i.e., machine readable instructions). In some implementations, the functionalities of the modules are combined into a single data processing component. In other versions, the respective functionalities of each of one or more of the modules are performed by a respective set of multiple data processing components.

Memory device 38 is accessible by controller 36. Memory device 38 stores process instructions (e.g., machine-readable code, such as computer software) for implementing methods executed by controller 36, as well as data that controller 36 generates or processes such as alignment correction data. Memory device 38 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices.

Controller 36 receives printjob commands and data from printjob source 39, which may be a computer source or other source of printjobs, in order to print an image. Controller 36 typically determines a print mask from the received data. A print mask refers to logic that includes control data determining which nozzles 26 of different printheads 14, 16, 20, 22 are fired at a given time to eject fluid in order to reproduce the printjob on print medium 1. The print mask may be stored in memory device 38. Controller 36 is operatively connected to treatment printhead 14, ink printhead assembly 15 and the respective reservoirs to control ejection of ink 42 and fixer 40 according to the print mask.

Controller 36 acts according to the print mask to provide motion control signals to (i) print media transport assembly 30 to advance print medium 1 in media advance direction 2, and (ii) carriage drive 28 to traverse carriage 12 across print medium 1 in transition direction 4 (e.g., along a scan axis 6 as shown in FIG. 5). Controller 36 may generate the motion control signals in consideration of estimated printhead misalignments, for example by using calibration data stored in memory device 38. Typically, controller 36 is operatively connected to optical sensor 24 to automatically estimate a misalignment of a printhead. Further, in operation for printing, controller 36 provide firing signals to nozzles 26 in the respective printheads in order to eject ink and/or fixer at particular locations on print medium 1 during transition of carriage 12 over print medium 1 according to a determined print mask. Controller 36 may selectively fire selected nozzles from a nozzle array of a printhead for accurately applying fixer or ink to individual dots in a print area.

A printer such as printing system 10 can be operated according to several different print modes. For example, in a single-pass print mode, after each printing pass the media is advanced a distance equal to the full span of a nozzle array (i.e., a swath width), such that each pass forms a complete strip of an image on the print medium. In a multi-pass print mode, the media advances only a fraction of the total length of a nozzle array after each printing pass of the printheads, and each strip of the image to be printed is formed in successive passes of the printheads. Further, printing can be unidirectional where the printheads only print when travelling in one direction along the scan axis of carriage 12. Printing can be bidirectional where the printheads print when travelling in a “forward pass” and also when travelling in a “return pass,” the print medium being advanced after each pass.

In the following, operation of printing system 10 in a bidirectional printing mode for reproducing an image in an image print area 43 according to a particular printjob is illustrated. In the example, printheads 14, 16, 18, 20, 22 are arranged in a staggered configuration as illustrated in FIG. 5. As print medium 1 is advanced in media advance direction 2, the bottom edge of image print area 43 first encounters nozzles of treatment printhead 14. In a first pass of carriage 12 over an image print area 43 in a forward direction (e.g., left-to right) controller 36 will selectively fire nozzles of treatment printhead 14 to apply fixer fluid along a swath width over a first portion of image print area 43 according to a print mask. After a first pass, print medium 1 is incrementally advanced by an advance distance. A fresh second portion of image print area 43 is positioned below treatment printhead 14; the first portion, already treated with fixer fluid, is now below ink treatment printheads 16, 18.

During a second pass of carriage 12 in a reverse direction (e.g., right-to-left) treatment printhead 14 and selected ink printheads are operated for applying fixer fluid over the second portion and ink over the first portion according to the particular print mask. Upon completion of a second pass, print medium 1 is advanced the same incremental distance such that a fresh third portion of image print area 43 is positioned below treatment printhead 14; the second portion, already treated with fixer fluid, is now below ink printheads 16, 18; the first portion, already treated with fixer fluid and printed with ink from ink printheads 16, 18, is now below ink printhead 20. Then, carriage 12 traverses again over image print area 43 while selectively operating treatment printhead 14 and ink printheads 16, 18, 20 to apply fixer and ink according to the particular print mask. In subsequent passes, printing system 1 operates analogously in order to reproduce a desired image on print medium 1.

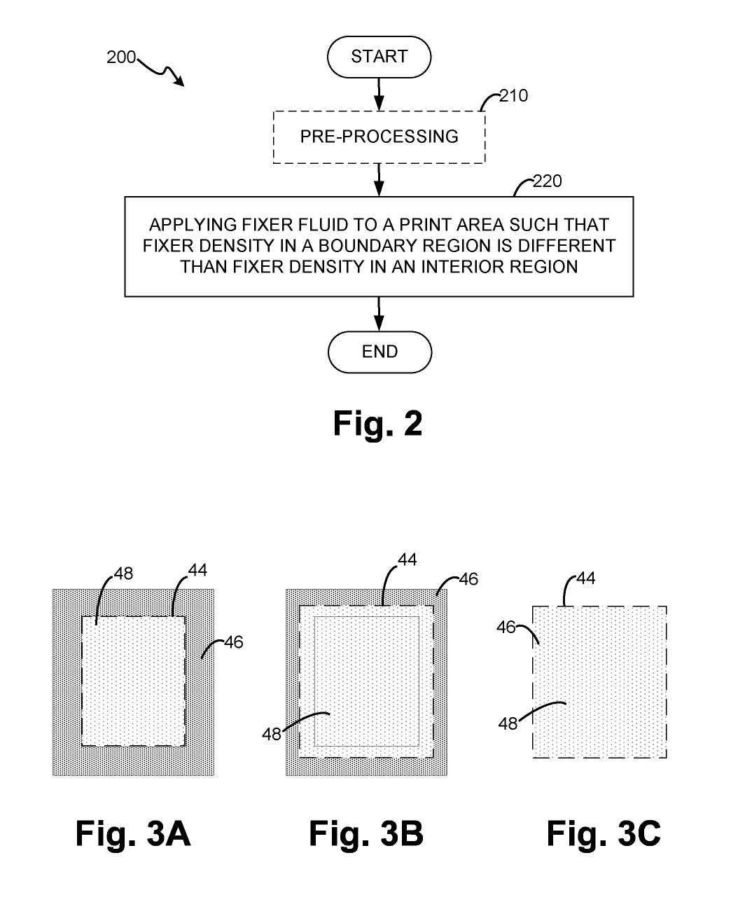

FIG. 2 is a process flow diagram of a method performed by a printing system according to an example herein. The depicted process flow 200 may be carried out by execution of sequences of executable instructions. In an example, the executable instructions are stored in a tangible machine readable storage medium such as, but not limited to, memory device 38. Process flow 200 may be carried out by controller 36 or any other suitable element of a printing system. In the following, process flow 200 is described with reference to elements depicted in FIGS. 3A, 3B, and 3C. These Figures are simplified diagrams of printing patterns printed by a printing system according to examples herein.

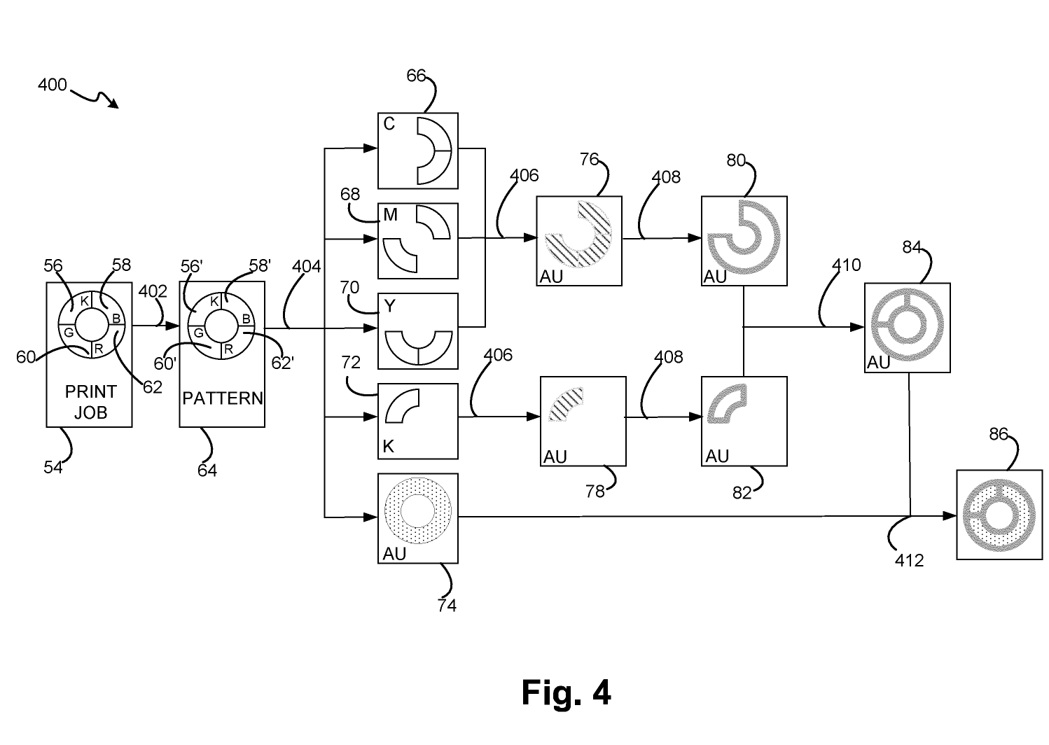

Process flow 200 may include a pre-processing step 210. Pre-processing step 210 may include receiving a printjob and processing the printjob for determining a print mask as illustrated with respect to FIG. 4. Controller 36 may use the print mask for determining how fixer fluid and treatment fluid are to be applied over particular areas corresponding to an image to be printed.

Process flow 200 includes a step 220 of applying a fixer fluid to a print area 44. The fixer fluid is applied such that the areal density of fixer fluid in a boundary region 46 of print area 44 is different than the areal density of fixer fluid in an interior region 48 of print area 44.

Printing system 10 may be operated in different manners for applying fixer fluid as described herein. For example, a fixer fluid may be applied at a first flow rate to the boundary region and at a second flow rate to the interior region. Additionally or alternatively thereto, different fixer fluid areal densities at different regions may be achieved by varying the transition speed of carriage 12. For example, carriage 12 may traverse at a first transition speed when treatment printhead 14 is over boundary region 46; carriage 12 may traverse at a second transition speed when treatment printhead 14 is over interior region 48. It will be understood that other modes of operating printing system 10 are suitable for achieving different areal densities at the different regions of print area 44.

Print area 44 corresponds to an image portion to be printed with a particular uniform color. Controller 36 may determine from a print mask the particular uniform color for printing print area 44. Controller 36 then operates ink printhead assembly 15 for applying ink onto print area 44 for reproducing the particular uniform color thereon according to the print mask.

It will be understood that application of the fixer fluid on a particular spot of print area 44 may be performed before, substantially simultaneously to, or after application of the ink for reproducing the particular uniform color on print area 44. The example illustrated above with respect to FIG. 5 describes application of the fixer fluid before application of the ink. Alternatively, the fixer fluid may be applied after the ink. For example, the staggered configuration of printheads shown in FIG. 5 may be inverted in the media advance direction 2. Thereby, treatment printhead 14 is the last printhead encountering a particular spot of image print area 43. Treatment printhead 14 would apply fixer fluid onto that spot after application of ink thereon. In a linear configuration of the printheads, the fixer fluid and the ink may be applied quasi-simultaneously by ejecting ink and fixer fluid for a particular spot at the same pass of carriage 12.

Typically, the fixer fluid is a pretreatment fluid. As used herein, a pretreatment fluid is a fixer fluid which achieves a higher fixing efficiency by being applied onto a particular spot before or substantially simultaneously to the application of ink. If the fixer fluid is a pretreatment fluid, the printheads are typically configured so as to apply the fixer fluid on a particular spot of print area 44 before application of ink on that particular spot, such as described above with respect to FIG. 5. The fixer fluid may also be suitable for being applied after ink to be treated.

Boundary region 46 may be located at different positions relative to the edge of print area 44. As used herein the edge of print area 44 refers to the limiting border of print area 44. FIG. 3A illustrates an example in which boundary region 46 is completely outside of print area 44. In particular, boundary region 46 is adjacent to the edge of print area 44 and extends outside of print area 44. FIG. 3B illustrates an example in which boundary region 46 partially overlaps print area 44. In particular, boundary region 46 overlaps the edge of print area 44 with a portion extending outside of print area 44 and another portion extending within print area 44. FIG. 3C illustrates an example in which boundary region 46 is completely contained within print area 44. In particular, boundary region 46 is placed adjacent to the edge of print area 44 and extends within print area 44.

Boundary region 46 may extend at least 0.01 mm outside of print area 44 or, more specifically, between 0.01 mm and 0.20 mm such as 0.10 mm. Further, boundary region 46 may extend at least 0.01 mm within print area 44 or, more specifically, between 0.01 mm and 0.20 mm such as 0.10 mm. Boundary region 46 may have a width of at least 0.01 mm or, more particularly, a width between 0.01 mm and 0.20 mm such as 0.10 mm.

A boundary region extending within and/or outside of the print area, as described above, facilitates accurate treatment of ink in a print area. It should be noted that accurate ink treatment may be compromised by misalignment of a treatment printhead; if a treatment printhead is misaligned and printing system 10 does not correct the misalignment (e.g., using a calibration procedure), then the positions at which fixer fluid is applied to does not correspond to the associated printing mask; thereby, ink at the borders of a print area may remain untreated. A boundary region treated with fixer fluid as described herein facilitates that ink at the borders of a print area is treated despite of uncorrected misalignment of a printhead.

As illustrated in FIGS. 3A, 3B and 3C, boundary region 46 may be a region which completely surrounds interior region 48 of print area 44. It will be understood that boundary region 46 may be a region partially surrounding interior region 48. Further, other print areas may be disposed contiguous to the edge of print area 44. FIG. 6 shows a simplified diagram of a printing pattern printed by a printing system according to examples herein. As illustrated, boundary region 46 extends along an edge 52 separating print area 44 from another print area 50. Print area 44 corresponds to an image portion to be printed with a uniform color; print area 50 corresponds to another image portion to be printed with another uniform color. Applying fixer fluid to boundary region 46 prevents color bleeding between both print areas 44, 50.

Process flow 200 may be performed such that interior region 48 has a lower areal density of fixer fluid than boundary region 46. For example, a fixer fluid may be applied at a first flow rate to the boundary region and at a second flow rate to the interior region, the first flow rate being higher than the second flow rate; the transition speed of carriage 12 is maintained uniform. Additionally or alternatively thereto, a higher areal density at the boundary region than at the interior region may be achieved by varying the transition speed of carriage 12. For example, carriage 12 may traverse at a first transition speed when treatment printhead 14 is over boundary region 46; carriage 12 may traverse at a second transition speed when treatment printhead 14 is over interior region 48; the first transition speed is lower than the second transition speed and the flow rate is maintained uniform. It will be understood that the above examples for realizing different areal densities are not limiting. Process flow 200 may be performed such that interior region 48 has a lower areal density of fixer fluid than boundary region 46 in an analogous manner.

Typically, after application of the fixer fluid and ink, the fluid vehicle of the fixer fluid evaporates and the fixer composition interacts with ink. Evaporation may be spontaneous or may be promoted by, for example, heating of the print area. After the fixer fluid evaporates, the respective regions include respective areal densities of fixer composition or of a product derived from the interaction of fixer composition and ink. Typically, these areal densities correlate with the areal densities of deposited fixer fluid in the respective regions.

As set forth above, interior region 48 may have a higher areal density of fixer fluid than boundary region 46. Typically, such a distribution of fixer fluid facilitates an efficient use of fixer fluid since in typical applications (however, not always) a higher quantity of fixer fluid is necessary for addressing color bleeding or feathering than for addressing coalescence.

According to examples, areal density of fixer fluid in the boundary region of the print area may be 50% to 200% higher than the areal density of fixer fluid in the interior region of the print area such as 100%. For example, the areal density of fixer fluid in the boundary region may be between 2 μg/mm² (i.e., micrograms per square millimeter) and 6 μg/mm², such as 4 μg/mm². The areal density of fixer fluid in the interior region may be, for example, between 0 μg/mm² and 4 μg/mm², such as 2 μg/mm².

It should be noted that the areal density of fixer fluid in the interior region may be next to zero or zero. For example, a particular quantity of fixer fluid may be applied to the boundary region and no fixer fluid may be applied to the interior region. A minimal or zero quantity of fixer fluid may be applied to the interior region if coalescence in the interior region is not an issue.

An advantageous effect of a boundary region with a higher fixer areal density as compared to the interior region can be understood from FIG. 6. In the illustrated example, boundary region 46 is exposed to color bleeding. In contrast, interior region 48 is exposed to coalescence. The fixer fluid is for preventing color bleeding and coalescence of ink applied to a print area. In this particular example, coalescence can be addressed with a lower quantity of fixer fluid than for addressing color bleeding. In the illustrated example, boundary region 46, which separates print area 44 from print area 50, contains a higher areal density of fixer fluid in order to prevent color bleeding; interior region 48 contains a lower areal density of fixer fluid in order to prevent coalescence.

The quantity of fixer fluid used in this example at print area 44 is lower than the quantity of fixer fluid that would be used if a uniform layer of fixer would be applied for addressing both coalescence and color bleeding. (A uniform layer would have to be applied such that the whole print area would contain the areal density necessary for addressing color bleeding.) However, the same efficiency is achieved for addressing these ink migration effects. Note that in the case of applying a uniform layer of fixer addressing both effects, the interior area would contain a fixer fluid areal density higher than the areal density in fact required for addressing coalescence.

In one example, a quantity of fixer fluid for addressing ink migration in a particular region of the print area is predetermined taking into account at least one of the following factors: (1) whether the particular region is an interior region; or (2) the particular ink selection to be applied onto the print area. The predetermination may be performed using empirical data. In particular, a set of test patches may be printed with a particular ink selection, each patch being treated with a different areal density of fixer fluid. From the test patches, it may be determined an areal density of fixer fluid that suitably addresses ink migration effects at the boundary region by assessing which patch shows a sufficiently low color bleeding and/or feathering. Further, it may be determined an areal density of fixer fluid that suitably addresses ink migration effects at the interior region by assessing which patch shows a sufficiently low coalescence. The predetermination may be performed for different test selections. Process flow 200 may be then executed such that the areal densities of fixer fluid in the different regions of print area 44 are selected according to the predetermined values.

FIG. 4 is a process flow shown as a graphical diagram of a method performed by a printing system according to an example herein. The depicted process flow 400 may be carried out by execution of sequences of executable instructions. In an example, the executable instructions are stored in a tangible machine readable storage medium such as, but not limited to, memory device 38. Process flow 200 may be carried out by controller 36 or any other suitable element of a printing system. The steps illustrated in FIG. 4 may be implemented as specific functions in an Application-Specific Integrated Circuit (ASIC) forming part or constituting controller 36.

Process flow 400 is for determining a printing mask. The print mask includes multiple data planes. Each data plane contains spatial data specifying where and how ink or fixer fluid is to be applied. For example, a data plane may specify the position of a spot over print area 44 and the quantity of fixer fluid to be applied on that spot. Thereby, controller 36 may operate printing system 10 to apply a selected quantity of fixer fluid at a desired spot. Typically, the determined print mask includes a data plane for each printhead of the printing system.

As set forth above, printjob source 39 may provide a printjob 54. In the example, printjob 54 corresponds to data of a digital image with four portions 56, 58, 60, 62, each portion has a respective uniform color. For example, image portion 56 may be black (K), image portion 58 may be a dark blue (B), image portion 60 may be green (G), and image portion 62 may be red (R). In this example, the digital image data is in a vectorial form. At step 402, controller 36 receives and processes printjob 54 for generating a print pattern 64. Thereby, controller 36 may convert vector information using rasterization or rendering to generate print pattern 64 that, when printed on print medium 1, reproduces the desired image according to printjob 54. Typically, this processing includes color-mapping and half-toning processes for transforming the colors of printjob 54 into colors included in the color gamut of printing system 1.

The generated print pattern includes different print areas corresponding, respectively, to image portions of printjob 54 to be printed with different uniform colors. For example, print pattern 64 includes: a print area 56′ corresponding to black image portion 56; a print area 58′ corresponding to dark blue image portion 58; a print area 60′ corresponding to green image portion 60; and a print area 62′ corresponding to red image portion 62.

Colors of print pattern 64 may correspond to base colors or secondary colors available to printing system 1. At step 404, controller 36 generates a set of ink data planes, each of the ink data planes corresponding to a base color available to printing system 10. For example, controller 36 may generate a cyan ink data plane 66, a magenta ink data plane 68, a yellow ink data plane 70 and a black ink data plane 72. The combination of the ink data planes renders the colors of print pattern 64.

In this particular example, it is advantageous to (a) have a first areal density of fixer fluid at the borders of the print areas associated to print pattern 64 in order to prevent feathering, (b) have also the first areal density of fixer fluid at the border separating a black image portion from other image portions in order to prevent color bleeding, and (c) a second areal density of fixer fluid in the interior regions of the print areas in order to prevent coalescence. Further, the fixer fluid and inks in this example are such that coalescence can be prevented with less fixer than for preventing color bleeding or feathering. Therefore, for this example, a first fixer fluid areal density (at the borders) higher than a second fixer fluid areal density (at the interior regions) is preferable.

In order to generate a treatment data plane according to these conditions, controller 36 determines multiple auxiliary data planes. Controller 36 determines at step 406 a first auxiliary data plane 74 corresponding to the combination of print areas associated to print pattern 64. First auxiliary data plane 74 is associated to interior regions of the print areas, which are to be printed with a lower fixer fluid areal density.

At steps 406, 408, and 410, controller 36 generates a second auxiliary data plane 84 associated to the boundary regions of the print areas which are to be printed with a higher fixer fluid areal density. In particular, at step 406, two further auxiliary planes 76, 78 are generated. Auxiliary data plane 76 corresponds to print areas for cyan, magenta and yellow inks. Auxiliary data plane 76 is generated by combining ink data planes 66, 68, 70. Auxiliary data plane 78 corresponds to print areas for black ink. Auxiliary data plane 78 is generated from ink data plane 72. At step 408, auxiliary data planes 80, 82 are generated by inflating the areas in auxiliary data planes 76, 78. Thereby, data corresponding to the boundary regions is created. In auxiliary data plane 80, the boundary region surrounds the combination of print areas for cyan, magenta, and yellow inks. In auxiliary data plane 82, the boundary region surrounds the print area for black ink. At step 410, second auxiliary plane 84 is generated by combining auxiliary plane 80 and auxiliary plane 82.

Finally, controller 36 generates a treatment data plane 86 by combining first auxiliary data plane 74 and second auxiliary data plane 84. Treatment data plane 86 corresponds to the distribution of fixer fluid to apply to print areas of the print pattern. Controller 36 can use treatment data plane 86 to determine the distribution of fixer fluid: treatment data plane 86 indicates positions at which fixer fluid is to be applied and the required quantity of fixer fluid to be applied at that position (which is associated with the areal density of fixer fluid at the particular region).

In this particular example, a print mask is generated by controller 36, the print mask including cyan ink data plane 66, magenta ink data plane 68, yellow ink data plane 70, black ink data plane 72 and treatment data plane 86. Controller 36 operates the printheads and motion drives based on the print mask in order to reproduce printjob 54 on print medium 1 with a pretreatment of the different print areas as described herein.

The fixer fluid can be applied uniformly within each particular region (i.e., the boundary region and the interior region of the print area). That is, fixer fluid in the particular regions is uniformly distributed within the tolerance limits of the particularly used printing system. Alternatively, the fixer fluid can be applied to a particular region according to a particular pattern. For example, treatment data plane 86 may be combined with a mask such that the areal density of fixer fluid in a particular region varies according to a selected pattern. For example, the mask may be such that fixer fluid is applied to a particular region to form cells therein. The pattern may correspond to a periodic or a non-periodic grid. For example, the pattern may correspond to a Voronoi grid.

It will be understood that examples herein can be realized using different inks and fixer fluids. For example, the fixer fluid may consist of a cationic polymer for reducing colorant mobility or “fix” ink on a print medium. The ink and fixer compositions may comprise standard dye-based or pigment based inkjet ink and fixer solutions. As a non-limiting example, the fixer may include a water-based solution including acids, salts and organic counter ions and polyelectrolytes. The fixer may include other components such as biocides that inhibit growth of microorganisms, chelating agents (e.g., EDTA) that eliminate deleterious effects of heavy metal impurities, buffers, ultraviolet absorbers, corrosion inhibitors, and viscosity modifiers, which may be added to improve various properties of the ink and fixer compositions. In another example, the fixer may include a component that reacts with the ink. The component may have a charge opposite to the charge of the ink. For instance, if the ink is anionic, the fixer may include a cationic component. In addition, the fixer may be substantially devoid of a colorant or may include a colorant that does not absorb visible light.

The fixer fluid may also include a precipitating agent, such as a salt or an acid. The salt may include cations, such as calcium, magnesium, aluminum, or combinations thereof. The salt may include, but is not limited to, calcium nitrate, magnesium nitrate, or ammonium nitrate. The acid may be any mineral acid or an organic acid, such as succinic acid or glutaric acid. The precipitating agent may be used to change the conductivity or the pH of the ink, causing the pigment in the ink to precipitate on the surface of the print medium. The fixer may be over-printed and/or under-printed on the print medium relative to the ink

Examples may be realized using water based latex-ink and fixer fluid suitable for fixing the latex-ink on the print medium. Thereby, methods and systems disclosed herein may be particularly advantageous. Latex-ink solutions may be more prone to color bleeding and coalescence due to the fluids in the ink solution. Further, a fixer fluid may significantly distort color reproduced by latex inks. This color distortion typically increases with increasing quantities of applied fixer fluid. Therefore, methods and systems described herein are particularly suitable for addressing the problems associated to migration of latex ink without compromising print quality. Other examples include solvent inks, water based inks, dye inks, or UV inks as well as fixer fluids appropriated thereto.

The print medium upon which the inkjet ink and/or fixer may be deposited may be any desired print medium. In a particular example, the print media may be a plain print medium or a commercially coated brochure print medium. Plain print media may include, but are not limited to, Hammermill® Fore DP paper, produced by International Paper Co. (Stamford, Conn.), HP Multi-Purpose paper, produced by Hewlett-Packard Inc. (Palo Alto, Calif.), uncoated polyester fabrics, polyester films, or vinyl banners. Commercially coated brochure print media, such as the type used to print brochures or business flyers, are typically hydrophobic and non-porous or less porous than plain paper, including “Lustro Laser”, produced by SD Warren Company (Muskegon, Mich.). Other examples include, among others, self-adhesive vinyls, any PVC banners, Polyproline media, polyethylene media, PET media, or polyester fabrics. The print medium may include a raw material. The print medium may be pre-treated or coated materials.

It will be appreciated that examples can be realized in the form of hardware, software module or a combination of hardware and the software module. Any such software module, which includes machine-readable instructions, may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of a non-transitory computer-readable storage medium that are suitable for storing a program or programs that, when executed, for example by a processor, implement a method according to examples herein. Accordingly, a program is contemplated comprising code for implementing a system or method as claimed in any of the accompanying claims and a non-transitory computer readable storage medium storing such a program.

In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the disclosed examples.

What is claimed is:

1. A printing method, comprising:
applying a fixer fluid to a print area in a manner such that the areal density of fixer fluid in a boundary region of the print area is different than the areal density of fixer fluid in an interior region of the print area,
the print area corresponding to an image portion to be printed with a uniform color.

2. The printing method of claim 1, wherein the areal density of fixer fluid in the boundary region of the print area is higher than the areal density of fixer fluid in the interior region of the print area.

3. The printing method of claim 2, wherein the areal density of fixer fluid in the boundary region of the print area is 50% to 200% higher than the areal density of fixer fluid in the interior region of the print area.

4. The printing method of claim 1, wherein the fixer fluid is a pretreatment fluid.

5. The printing method of claim 1, wherein the fixer fluid is for preventing at least color bleeding and coalescence of ink applied to the print area.

6. The printing method of claim 1, wherein the boundary region extends along an edge separating the prim area from at least another print area corresponding to an image portion to be printed with a second uniform color.

7. The printing method of claim 1, wherein the boundary region is a region completely surrounding the interior region of the print area.

8. The printing method of claim 1 further comprising applying latex ink for reproducing the uniform color on the print area.

9. The printing method of claim 1, wherein the boundary region has a width of at least 0.2 mm.

10. The printing method of claim 1, wherein the boundary region extends at least 0.05 mm within the print area.

11. The printing method of claim 1, wherein the boundary region extends at least 0.05 mm outside the print area.

12. The printing method of claim 1, wherein applying the fixer fluid includes:
determining a first auxiliary data plane corresponding to the interior region;
determining a second auxiliary data plane corresponding to the boundary region;
determining the distribution of fixer fluid to apply to the print area by combining the first auxiliary data plane and the second auxiliary data plane; and
applying the fixer fluid according to the determined distribution.

13. A printing system for printing to print medium comprising:
a controller configured to:
control an ink printhead assembly so as to apply ink on a print area for reproducing a uniform color thereon; and
control a treatment printhead so as to apply a first areal density of fixer fluid in a boundary region of the print area and a second areal density of fixer fluid in an interior region of the print area,
wherein the treatment printhead is configured to eject fixer fluid, and the ink printhead assembly includes a plurality of ink printheads configured to eject ink.

14. The printing system of claim 1, wherein the first areal density is higher than the second areal density.

15. A tangible machine readable storage medium storing instructions that when executed implement a method performed by a printing system, comprising:
applying fixer fluid to a print area in a manner such that the areal density of fixer fluid in a boundary region of the print area is different than the areal density of fixer fluid in an interior region the print area,
the print area corresponding to an image portion to be printed with a uniform color.
